(19) United States
(12) Patent Application Publication
(10) Pub. No.: US 2008/0152341 A1
(43) Pub. Date: Jun. 26, 2008

(54) OPTICAL NETWORK TRANSMISSION CHANNEL FAILOVER SWITCHING DEVICE

(75) Inventors: Fu-Chun Hung, Taipei (TW); Hsuan-Hung Wu, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC MULTIMEDIA & TELECOM CORPORATION, Taipei (TW)

(21) Appl. No.: 11/748,338

(22) Filed: May 14, 2007

(30) Foreign Application Priority Data
Dec. 20, 2006 (TW) 095147832

(51) Int. Cl. G02F 1/00; H04J 14/02

(52) U.S. Cl. 398/2; 370/217; 398/7

(57) ABSTRACT

An optical network transmission channel failover switching device is proposed, which is designed for use with an optical network for providing the optical network with a transmission channel failover switching function, and which is characterized by the provision of a pair of one-to-two (1×2) type of optical switch and a monitoring beam generating module for providing a backup channel monitoring function that can be used to activate the switching action. This feature allows the utilization of the optical network system to have enhanced reliability, serviceability, and security.

### BACKGROUND OF THE INVENTION

1. Field of the Invention

This invention relates to optical networking technology, and more particularly, to an optical network transmission channel failover switching device which is designed for use in conjunction with an optical network for providing a transmission channel failover switching function

2. Description of Related Art

Optical networking is a communication technology that utilizes optical fibers and laser beams for data transmission between computers, telephones and other electronic devices. Optical networks can be used to transmit signals either in analog or digital forms. Since laser beams are much higher in frequency than electrical and radio signals, optical networking is far more reliable and has far greater transmission capacity than traditional cable and radio communications.

PON (Passive Optical Network) systems are a widely employed technology for data communication between the Internet and local area networks that are used for connection to private users and small business entities. In practice, a PON system typically utilizes just one single strand of optical fiber for two-way transmission of optical signals to and from the client sites. One drawback to the traditional single-fiber two-way PON systems, however, is that when the single fiber is damaged or fractured, the data communication to the client sites is entirely disconnected. One solution to this problem is to provide two channels (i.e., two strands of fibers) in the optical transmission path: a primary channel and a secondary channel, where the primary channel is initially set to be responsible for optical transmission while the secondary channel is set to standby mode, such that in the event of a failure to the primary channel (such as when fractured), the failed primary channel can be failover switched to the backup channel.

To achieve the above-mentioned failover purpose, it is needed to develop an optical transmission channel failover switching device capable of switching the primary channel over to the backup channel in the event of a failure to the primary channel. Presently, one solution is to utilize two one-to-two (1×2) optical switches in an optical auto switch (OAS) to provide the desired failover switching function. One drawback to this solution, however, is that it lacks the capability of monitoring the backup channel to check whether the backup channel is in good usable condition when the primary channel fails. As a consequence, if the backup channel is also in unusable condition when the primary channel fails, it will cause the entire optical network system to shut down, resulting in degraded serviceability and security to network services.

### SUMMARY OF THE INVENTION

It is therefore an objective of this invention to provide an optical network transmission channel failover switching device which is capable of providing a backup channel monitoring capability for failover switching of the primary channel.

The optical network transmission channel failover switching device according to the invention is designed for use with an optical network, such as a local area network used for linking to the Internet or a telephone network, for the purpose of providing the optical network with a transmission channel failover switching function.

In architecture, the optical network transmission channel failover switching device according to the invention comprises: (A) an equipment-side interface, which includes an input port and an output port; (B) a channel-side interface, which includes a first transmission port, a second transmission port, a first reception port, and a second reception port; (C) a first optical switching module, which includes a first connecting port, a second connecting port, and a third connecting port, and which is capable of providing a one-to-two optical switching function for connecting the first connecting port selectively to either one of the second connecting port and the third connecting port; wherein the first connecting port is connected to the input port of the equipment-side interface, the second connecting port is connected via the first transmission port of the channel-side interface to the primary channel of the optical fiber, and the third connecting port is connected via the second transmission port of the channel-side interface to the backup channel of the optical fiber; (D) a second optical switching module, which includes a first connecting port, a second connecting port, and a third connecting port, and is capable of providing a one-to-two optical switching function for connecting the first connecting port selectively to either one of the second connecting port and the third connecting port; and wherein the first connecting port is connected to the output port of the equipment-side interface, the second connecting port is used for connection via the first input port of the channel-side interface to the primary channel of the optical fiber, and the third connecting port is used for connection via the second reception port of the channel-side interface to the backup channel of the optical fiber; (E) a monitoring beam generating module, which is capable of generating at least two monitoring beams including a first monitoring beam and a second monitoring beam, and further capable of injecting the first monitoring beam and the second monitoring beam respectively via the first transmission port and the second transmission port of the channel-side interface to the primary channel and the backup channel of the optical fiber; (F) a first optical sensing module, which is coupled to the first input port of the channel-side interface for detecting whether the primary channel of the optical fiber can normally transmit the first monitoring beam injected by the monitoring beam generating module therein; and if yes, capable of generating a first opto-electro signal; (G) a second optical sensing module, which is coupled to the second reception port of the channel-side interface for detecting whether the backup channel of the optical fiber can normally transmit the second monitoring beam injected by the monitoring beam generating module therein; and if yes, capable of generating a second opto-electro signal; and (H) a communication module, which is capable of responding to the first opto-electro signal and the second opto-electro signal by generating a corresponding switching control signal to activate the first optical switching module and the second optical switching module to perform a failover switching action for switching the failed primary channel over to the backup channel.

The optical network transmission channel failover switching device according to the invention is characterized by the provision of a pair of one-to-two (1×2) type of optical switch and a monitoring beam generating module for providing a backup channel monitoring function that can be used to activate the switching action. This feature allows the utilization of the optical network system to have enhanced reliability, serviceability, and security.

### BRIEF DESCRIPTION OF DRAWINGS

The invention can be more fully understood by reading the following detailed description of the preferred embodiments, with reference made to the accompanying drawings, wherein:

FIG. 1A is a schematic diagram showing the application of the optical network transmission channel failover switching device of the invention with a typical type of optical network system;

FIG. 1B is a schematic diagram showing the application of the invention with an advanced type of optical network system having EDFA circuitry;

FIG. 2 is a schematic diagram showing a first preferred embodiment of the optical network transmission channel failover switching device of the invention;

FIG. 3 is a schematic diagram showing a first preferred embodiment of the optical network transmission channel failover switching device of the invention;

FIG. 4 is a schematic diagram showing a second preferred embodiment of the optical network transmission channel failover switching device of the invention;

FIG. 5 is a schematic diagram showing a third preferred embodiment of the optical network transmission channel failover switching device of the invention;

FIG. 6 is a schematic diagram showing a fourth preferred embodiment of the optical network transmission channel failover switching device of the invention; and

FIG. 7 is a schematic diagram showing a fifth preferred embodiment of the optical network transmission channel failover switching device of the invention.

### DETAILED DESCRIPTION OF PREFERRED EMBODIMENTS

The optical network transmission channel failover switching device according to the invention is disclosed in full details by way of preferred embodiments in the following with reference to the accompanying drawings.

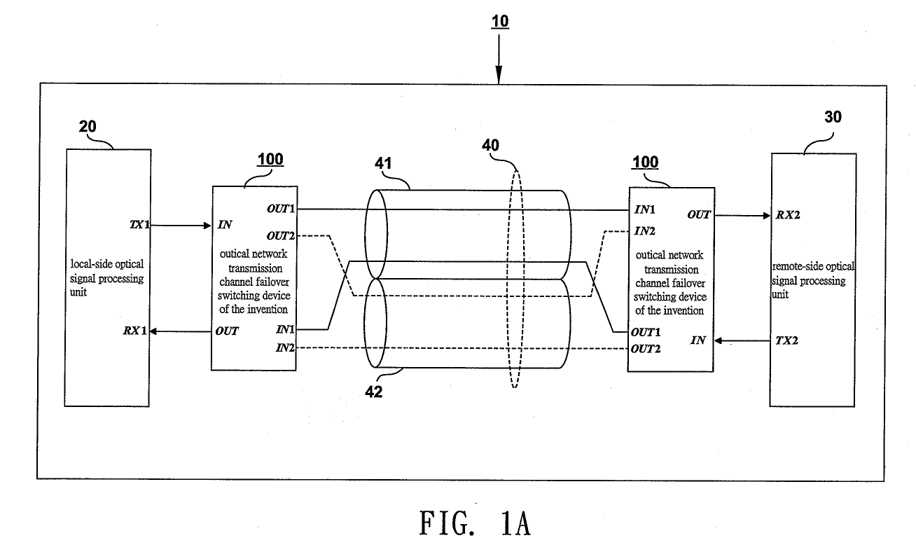

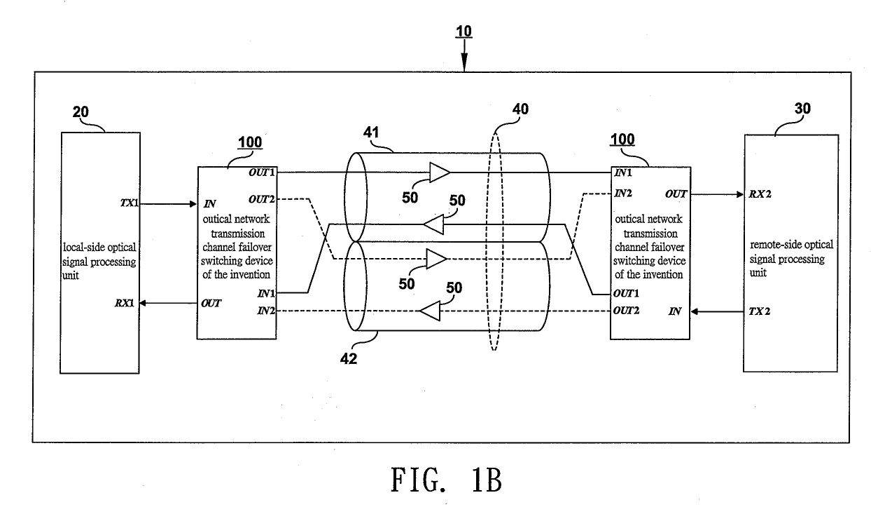

FIGS. 1A-1B are two schematic diagrams used to illustrate the application of the optical network transmission channel failover switching device according to the invention (as the block indicated by the reference numeral 100) with an optical network system 10. It is to be noted that in this application, two devices of the invention should be used. FIG. 1A shows the application of the invention with a typical optical network system, while FIG. 1B shows the application of the invention with an advanced type of optical network system that is equipped with EDFA (Erbium-Doped Fiber Amplifier) modules 50.

As shown, the optical network system 10 is equipped with a local-side optical signal processing unit 20 and a remote-side optical signal processing unit 30 which are interconnected to each other via an optical fiber 40 having a primary channel 41 and a backup channel 42. The backup channel 42 is used as a redundant backup for the primary channel 41. In Internet applications, for example, the optical network system 10 can be a PON (Passive Optical Network) system, and the local-side optical signal processing unit 20 is an optical line terminal (OLT), while the remote-side optical signal processing unit 30 is an optical network unit (ONU). The local-side optical signal processing unit 20 and the remote-side optical signal processing unit 30 each have a beam emitting port TX1, TX2 for emitting an optical signal beam to the opposite side and a beam reception port RX1, RX2 for receiving the optical signal beam from the opposite side.

In practice, the primary channel 41 is used as the main transmission route for the local-side optical signal processing unit 20 and the remote-side optical signal processing unit 30 to exchange optical signals, i.e., the local-side optical signal processing unit 20 can output an optical signal from its beam emitting port TX1 and transmit the outputted optical signal via the primary channel 41 of the optical fiber 40 to the beam reception port RX2 of the remote-side optical signal processing unit 30; and vice versa, the remote-side optical signal processing unit 30 can output an optical signal from its beam emitting port TX2 and transmit the outputted optical signal also via the primary channel 41 of the optical fiber 40 to the beam reception port RX1 of the local-side optical signal processing unit 20. In the event of a failure to the primary channel 41, the two optical network transmission channel failover switching devices of the invention 100 will be simultaneously activated for failover switching to the backup channel 42, such that under this condition, the local-side optical signal processing unit 20 and the remote-side optical signal processing unit 30 can nevertheless use the backup channel 42 for exchange of optical signals.

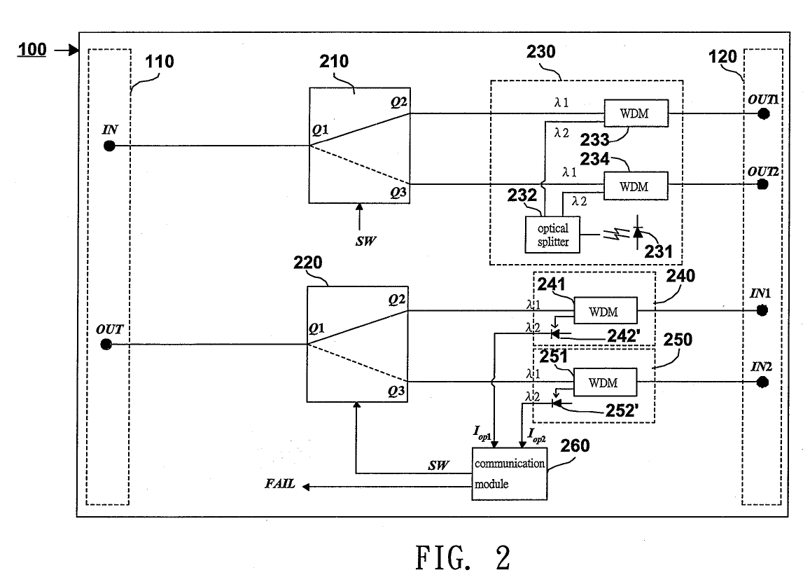

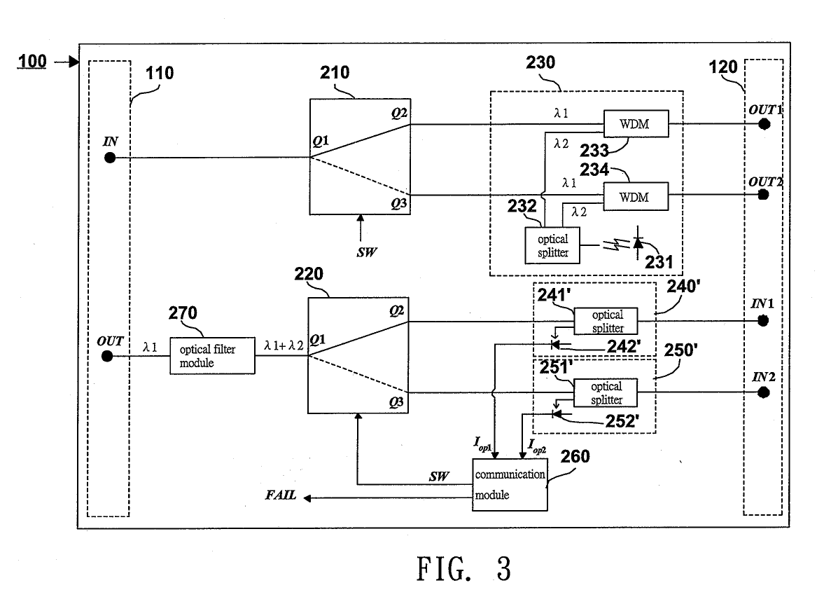

As shown in FIG. 2, the optical network transmission channel failover switching devices of the invention 100 each comprises: (A) an equipment-side interface 110; (B) a channel-side interface 120; (C) a first optical switching module 210; (D) a second optical switching module 220; (E) a monitoring beam generating module 230; (F) a first optical sensing module 240; (G) a second optical sensing module 250; and (H) a communication module 260; and as shown in FIG. 3, can further optionally comprise an optical filter module 270. Firstly, the respective attributes and operations of these modules are described in details in the following.

The equipment-side interface 110 is used for coupling to either the local-side optical signal processing unit 20 or the remote-side optical signal processing unit 30, and which includes an input port IN and an output port OUT. As shown in FIGS. 1A-1B, its input port IN is used for connection to either the beam emitting port TX1 of the local-side optical signal processing unit 20 or the beam emitting port TX2 the remote-side optical signal processing unit 30, while its output port OUT is used for connection to the beam reception port RX1/RX2 of the same.

The channel-side interface 120 is used for coupling to the optical fiber 40, and which includes a first transmission port OUT1, a second transmission port OUT2, a first reception port IN1, and a second reception port IN2. As shown in FIGS. 1A-1B, the first transmission port OUT1 is used for connection to the primary channel 41, the second transmission port OUT2 is used for connection to the backup channel 42, the first input port IN1 is used for connection to the primary channel 41, and the second reception port IN2 is used for connection to the backup channel 42.

The first optical switching module 210 is a 1×2 (one-to-two) type of optical switch, which includes a first connecting port Q1, a second connecting port Q2, and a third connecting port Q3, and which is capable of providing a one-to-two optical switching function for connecting the first connecting port Q1 selectively to either the second connecting port Q2 or the third connecting port Q3. In assembly, the first connecting port Q1 is connected to the input port IN of the equipment-side interface 110; the second connecting port Q2 is connected via the first transmission port OUT1 of the channel-side interface 120 to the primary channel 41 of the optical fiber 40; and the third connecting port Q3 is connected via the second transmission port OUT2 of the channel-side interface 120 to the backup channel 42 of the optical fiber 40. The switching action of the first optical switching module 210 is controlled by a switching control signal SW for selectively connecting the first connecting port Q1 either to the second connecting port Q2 or to the third connecting port Q3.

The second optical switching module 220 is also a 1×2 (one-to-two) type of optical switch, which includes a first connecting port Q1, a second connecting port Q2, and a third connecting port Q3, and which is capable of providing a one-to-two optical switching function for selectively connecting the first connecting port Q1 to either the second connecting port Q2 or the third connecting port Q3. In assembly, the first connecting port Q1 is connected via the output port OUT of the equipment-side interface 110 to the beam reception port RX1, RX2 of the local-side optical signal processing unit 20 or the remote-side optical signal processing unit 30; the second connecting port Q2 is used for connection via the first input port IN1 of the channel-side interface 120 to the primary channel 41 of the optical fiber 40; and the third connecting port Q3 is used for connection via the second reception port IN2 of the channel-side interface 120 to the backup channel 42 of the optical fiber 40. The switching action of the second optical switching module 220 is also controlled by the above-mentioned switching control signal SW for connecting the first connecting port Q1 selectively to either the second connecting port Q2 or the third connecting port Q3.

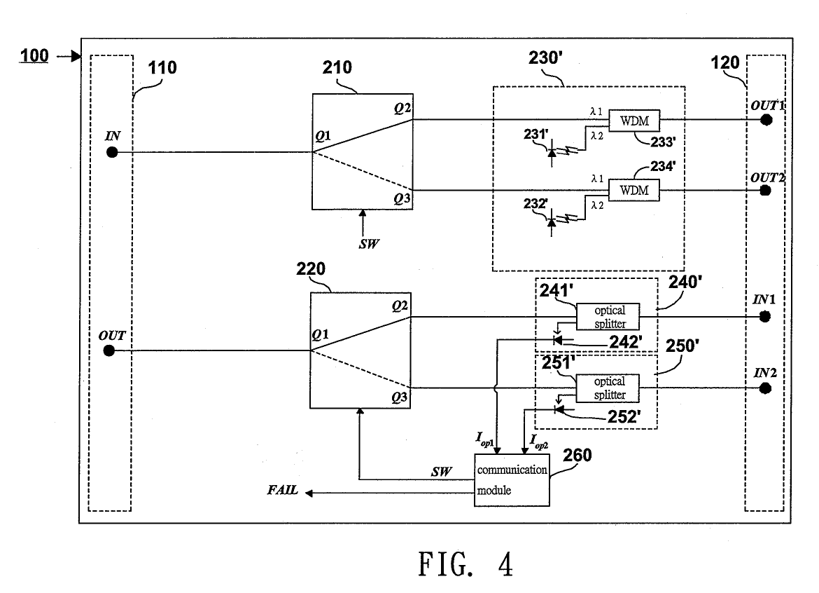

The monitoring beam generating module 230 is designed for generation of at least two monitoring beams including a first monitoring beam and a second monitoring beam, and capable of injecting the first monitoring beam and the second monitoring beam respectively via the first transmission port OUT1 and the second transmission port OUT2 of the channel-side interface 120 to the primary channel 41 and the backup channel 42 of the optical fiber 40. In practical implementation, for example, this monitoring beam generating module 230 can be realized in various different embodiments, as respectively shown in FIG. 2, FIG. 3, and FIG. 4.

As shown in FIG. 2, the monitoring beam generating module 230 in accordance with the first preferred embodiment includes a laser diode 231, an optical splitter 232, a first WDM (Wavelength Division Multiplexer) unit 233, and a second WDM unit 234. In operation, the laser diode 231 is capable of generating a laser beam of wavelength λ₂; the optical splitter 232 is capable of splitting the laser beam generated by the laser diode 231 into two beams, respectively serving as the above-mentioned first monitoring beam and the second monitoring beam; the first WDM unit 233 and the second WDM unit 234 are used for injecting the first monitoring beam (wavelength λ₂) and the second monitoring beam (wavelength λ₂) respectively in a multiplexed manner with the optical signal beam λ₁ into the primary channel 41 and the backup channel 42 of the optical fiber 40.

As shown in FIG. 4, the second preferred embodiment of the monitoring beam generating module (here designated by the reference numeral 230′) includes a first laser diode 231′, a second laser diode 232′, a first WDM unit 233′, and a second WDM unit 234′. In operation, the first laser diode 231′ is capable of generating a laser beam of wavelength λ₂ for serving as the first monitoring beam; the second laser diode 232′ is capable of generating a laser beam of the same wavelength λ₂ for serving as the second monitoring beam; the first WDM unit 233′ and the second WDM unit 234′ are used for injecting the first monitoring beam (wavelength λ₂) and the second monitoring beam (wavelength λ₂) respectively in a multiplexed manner with the optical signal beam λ₁ into the primary channel 41 and the backup channel 42 of the optical fiber 40.

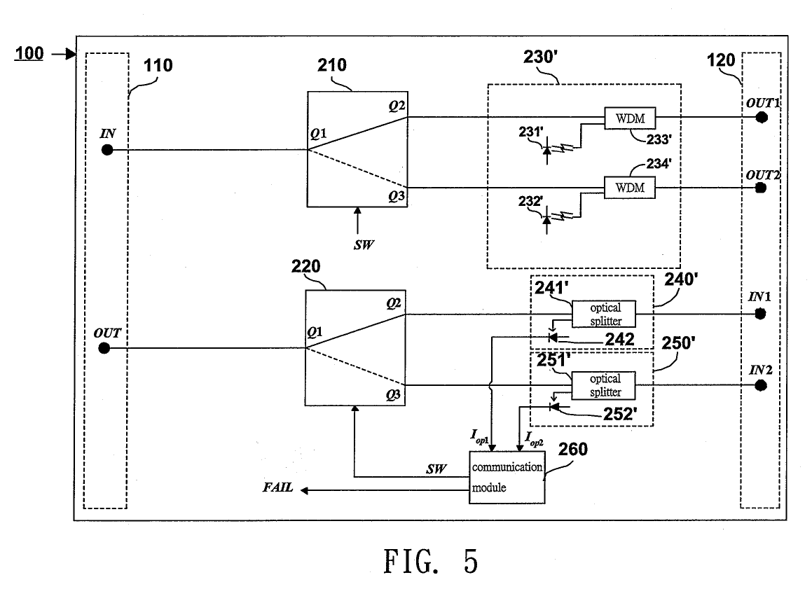

Further, as shown in FIG. 5, the third preferred embodiment of the monitoring beam generating module 230 is implemented with optical splitters 233′, 234′ in lieu of the WDM units in the second preferred embodiment.

As shown in FIG. 2, the first optical sensing module 240 and the second optical sensing module 250 are respectively coupled to the first input port IN1 and the second reception port IN2 of the channel-side interface 120 for respectively detecting whether the primary channel 41 and the backup channel 42 of the optical fiber 40 can operate normally. If the primary channel 41 operates normally, the optical signal beam λ₁ and the second monitoring beam λ₂ traveling therein will cause the first optical sensing module 240 to responsively generate a first opto-electro signal Iₒₚ₁; and similarly, if the backup channel 42 operates normally, the optical signal beam λ₁ and the second monitoring beam λ₂ traveling therein will cause the second optical sensing module 250 to responsively generate a second opto-electro signal Iₒₚ₂. In practice, the first optical sensing module 240 and the first optical sensing module 240 can be realized in two different various embodiments, as respectively shown in FIG. 2 and FIG. 3.

As shown in FIG. 2, the first optical sensing module 240 in accordance with the first preferred embodiment is composed of a WDM (Wavelength Division Multiplexer) unit 241 and a photo diode (PD) 242; wherein the WDM unit 241 is connected via the first input port IN1 of the channel-side interface 120 to the primary channel 41 of the optical fiber 40 for intercepting the optical signal beam λ₁ in the primary channel 41; while the photo diode 242 is capable of sensing the first monitoring beam λ₂ intercepted by the WDM unit 241 and responsively generating the first opto-electro signal Iₒₚ₁.

The second optical sensing module 250 in accordance with the first preferred embodiment is also composed of a WDM unit 251 and a photo diode (PD) 252; wherein the WDM unit 251 is connected via the second reception port IN2 of the channel-side interface 120 to the backup channel 42 of the optical fiber 40 for intercepting the optical signal beam λ₁ in the backup channel 42; while the photo diode 252 is capable of sensing the second monitoring beam λ₂ intercepted by the WDM unit 251 and responsively generating the second opto-electro signal Iₒₚ₂.

Further, as shown in FIG. 3, the first optical sensing module 240′ in accordance with the second preferred embodiment is composed of an optical splitter 241′ (in lieu of the WDM unit) and a photo diode (PD) 242′; wherein the optical splitter 241′ is connected via the first input port IN1 of the channel-side interface 120 to the primary channel 41 of the optical fiber 40 for intercepting the optical signal beam λ₁ and the first monitoring beam λ₂ traveling in the primary channel 41; while the photo diode 242′ is capable of sensing the optical signal beam λ₁ and the first monitoring beam λ₂ intercepted by the optical splitter 241′ and responsively generating the first opto-electro signal Iₒₚ₁.

Similarly, the second optical sensing module 250′ in accordance with the second preferred embodiment is composed of an optical splitter 251′ (in lieu of the WDM unit) and a photo diode (PD) 252′; wherein the optical splitter 251′ is connected via the second reception port IN2 of the channel-side interface 120 to the backup channel 42 of the optical fiber 40 for intercepting the optical signal beam λ₁ and the second monitoring beam λ₂ traveling in the backup channel 42; while the photo diode 252′ is capable of sensing the optical signal beam λ₁ and the second monitoring beam λ₂ intercepted by the optical splitter 251′ and responsively generating the second opto-electro signal Iₒₚ₂.

The communication module 260 is capable of responding to the first opto-electro signal Iₒₚ₁ and the second opto-electro signal Iₒₚ₂ by generating a corresponding switching control signal SW to activate the first optical switching module 210 and the second optical switching module 220 to perform a failover switching action between the primary channel 41 and the backup channel 42 of the optical fiber 40. In practice, the switching control signal SW can be implemented in such a manner that when the light intensity at the first input port IN1 is higher than a threshold value (indicating that the primary channel 41 can operate normally), then SW=0 and thus no failover switching action is activated; and when the light intensity at the first input port IN1 isn't only lower than the threshold value(indicating that the primary channel 41 fails to work normally) but the light intensity at the second reception port IN2 is higher than the threshold value (indicating that the backup channel 42 can work normally), then SW=1 and a failover switching action is enabled. In practice, for example, the communication module 260 is integrated to an ERC (Embedded Remote Communication) circuit. Moreover, if the light intensity at the second reception port IN2 is lower than the threshold value, it indicates that the backup channel 42 also fails to work normally, and the communication module 260 will responsively generate a backup-channel failure notifying message FAIL and display the FAIL message on a network workstation (not shown) or directly on the local-side optical signal processing unit 20 or the remote-side optical signal processing unit 30 with a flashing light or beep to notify the network management personnel to perform maintenance work on the optical fiber 40.

As shown in FIG. 3, the optical filter module 270 is optionally connected between the output port OUT of the equipment-side interface 110 and the first connecting port Q1 of the second optical switching module 220, and which has a pass bandwidth of λ₁ for filtering out all the undesired wavelength of the optical signal beam other than its designated wavelength of λ₁. The filtered optical signal beam λ₁ is then transferred via the equipment-side interface 110 to the beam reception port RX1 of the local-side optical signal processing unit 20. The provision of this optical filter module 270 allows the beam reception port RX1 to receive a clean version of the optical signal beam λ₁ without causing interferences owing to other wavelength signal.

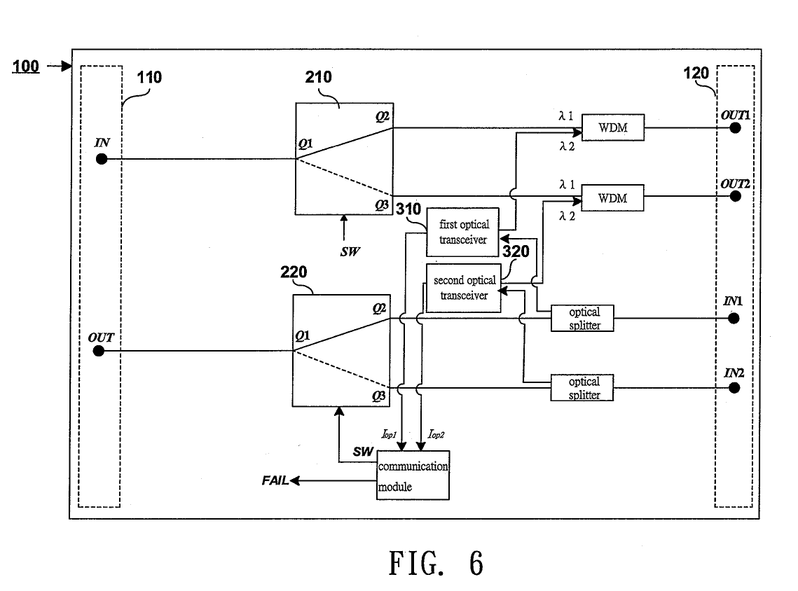

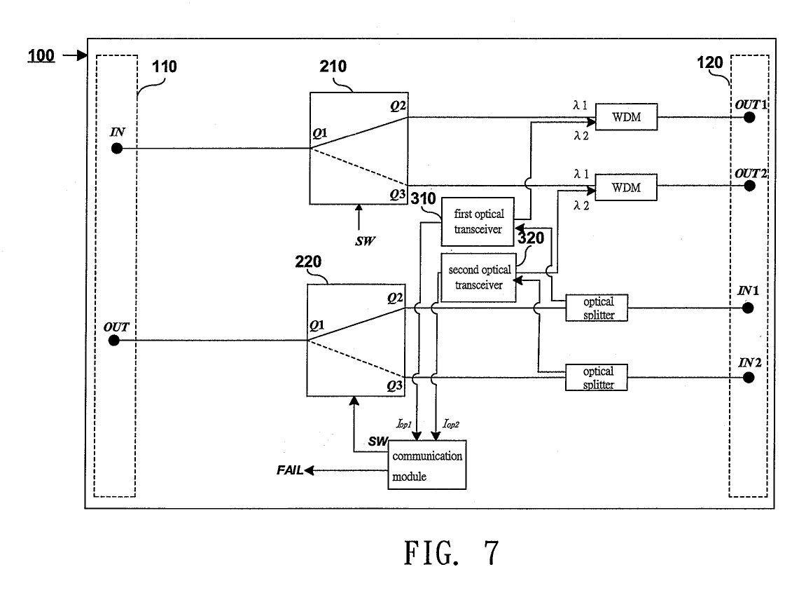

In addition, FIG. 6 and FIG. 7 respectively show two different embodiments of the combined structure of the monitoring beam generating module 230, the first optical sensing module 240, and the second optical sensing module 250. The embodiment shown in FIG. 6 is largely identical with that shown in FIG. 4 except that the embodiment of FIG. 6 utilizes two optical transceivers, a first optical transceiver 310 and a second optical transceiver 320. The first optical transceiver 310 is functionally equivalent to the combination of the first laser diode 231′ and the first photo diode 242′ shown in FIG. 4; while the second optical transceiver 320 is functionally equivalent to the combination of the second laser diode 232′ and the second photo diode 252′ shown in FIG. 4. In operation, the first optical transceiver 310 and the second optical transceiver 320 are capable of receiving the optical beam sensed by the first optical sensing module 240′ and the second optical sensing module 250′ and then injecting optical beams of first laser diode 231′ and second laser diode 232′ into to the first WDM unit 233′ and the second WDM unit 234′ for use to serve respectively as the first monitoring beam and the second monitoring beam, and meanwhile detecting whether the optical signal beam and the monitoring beams are being transmitted normally through the primary channel 41 and the backup channel 42.

The embodiment of FIG. 7 is largely identical with the embodiment of FIG. 5 except that the embodiment of FIG. 7 utilizes two optical transceivers, a first optical transceiver 310 and a second optical transceiver 320, in lieu of the first laser diode 231′, the second laser diode 232′, the first photo diode 242′, and the second photo diode 252′ shown in FIG. 5.

The following is a detailed description of a practical application example of the optical network transmission channel failover switching devices 100 of the invention during actual operation.

Alternatively, the optical network transmission channel failover switching devices 100 of the invention can be operated in another manner as described in the following.

At start of operation, the optical network transmission channel failover switching devices of the invention 100 are preset to connect both the local-side optical signal processing unit 20 and the remote-side optical signal processing unit 30 to the primary channel 41 of the optical fiber 40; i.e., initially, both the first optical switching module 210 and the second optical switching module 220 are preset to connect their first connecting port Q1 to the second connecting port Q2. This connection state allows the local-side optical signal processing unit 20 and the remote-side optical signal processing unit 30 to exchange optical signals via the primary channel 41. At the same time, the monitoring beam generating module 230′ shown in FIG. 5 is activated to generate a laser beam of the same wavelength λ₂ to serve as a second monitoring beam (meantime the first monitoring beam is off), which is then injected via the second transmission port OUT2 of the channel-side interface 120 into the backup channel 42 of the optical fiber 40.

When the primary channel 41 operates normally, the optical signal beam λ₁ traveling therein will be sensed by the photo diode 242 in the first optical sensing module 240. If the light intensity is higher than a preset threshold value, it causes the photo diode 242 to generate a first opto-electro signal Iₒₚ₁. In this case, the communication module 260 responsively outputs SW=0, which causes no switching action to the first optical switching module 210 and the second optical switching module 220. Therefore, the first optical switching module 210 and the second optical switching module 220 still connect the primary channel 41 for transmission of optical signal beams.

On the other hand, in the event of a failure to the primary channel 41, the light intensity of the optical signal beam λ₁ at the first input port IN1 drops below the threshold value, which then causes the output of Iₒₚ₁ from the photo diode 242 to be interrupted. In this case, if the backup channel 42 is still in good condition, the second monitoring beam λ₂ traveling inside the backup channel 42 can be detected by the photo diode 252 of the second optical sensing module 250 (i.e., the light intensity at the second reception port IN2 is higher than the threshold value). This causes the communication module 260 to output SW=1 to enable a switching action to the first optical switching module 210 and the second optical switching module 220. In response, the first optical switching module 210 is switched over from the original (Q1→Q2) connection to the (Q1→Q3) connection; and concurrently in a similar manner, the second optical switching module 220 is also switched over from the original (Q1→Q2) connection to the (Q1→Q3) connection. At the same time, this switching control signal SW is also transmitted via the backup channel 42 to the opposite side for the optical network transmission channel failover switching device of the invention 100 on the opposite side to perform a similar switching action, i.e., causing the first optical switching module 210 to be switched over from the original (Q1→Q2) connection to the (Q1→Q3) connection; and concurrently, causing the second optical switching module 220 to be switched over from the original (Q1→Q2) connection to the (Q1→Q3) connection. As a result, the primary channel 41 is failover switched to the backup channel 42.

If the backup channel 42 also fails to work normally, the communication module 260 will responsively generate a backup-channel failure notifying message FAIL to notify the network management personnel to perform maintenance work on the optical fiber 40.

In conclusion, the invention provides an optical network transmission channel failover switching device which is designed for use with an optical network for providing the optical network with a transmission channel failover switching function, and which is characterized by the provision of a pair of one-to-two (1×2) type of optical switch and a monitoring beam generating module for providing a backup channel monitoring function that can be used to activate the switching action. This feature allows the utilization of the optical network system to have enhanced reliability, serviceability, and security. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An optical network transmission channel failover switching device for use with an optical network for providing the optical network with a transmission channel failover switching function, wherein the optical network is equipped with a local-side optical signal processing unit and a remote-side optical signal processing unit, each having a beam emitting port and a beam reception port and being interconnected via an optical fiber having at least a primary channel and a backup channel;
the optical network transmission channel failover switching device comprising:
an equipment-side interface, which includes an input port and an output port;
a channel-side interface, which includes a first transmission port, a second transmission port, a first reception port, and a second reception port;
a first optical switching module, which includes a first connecting port, a second connecting port, and a third connecting port, and which is capable of providing a one-to-two optical switching function for connecting the first connecting port selectively to either one of the second connecting port and the third connecting port; wherein the first connecting port is connected to the input port of the equipment-side interface, the second connecting port is connected via the first transmission port of the channel-side interface to the primary channel of the optical fiber, and the third connecting port is connected via the second transmission port of the channel-side interface to the backup channel of the optical fiber;
a second optical switching module, which includes a first connecting port, a second connecting port, and a third connecting port, and is capable of providing a one-to-two optical switching function for connecting the first connecting port selectively to either one of the second connecting port and the third connecting port; and wherein the first connecting port is connected to the output port of the equipment-side interface, the second connecting port is used for connection via the first input port of the channel-side interface to the primary channel of the optical fiber, and the third connecting port is used for connection via the second reception port of the channel-side interface to the backup channel of the optical fiber;
a monitoring beam generating module, which is capable of generating at least two monitoring beams for use to serve respectively as a first monitoring beam and a second monitoring beam, and further capable of injecting the first monitoring beam and the second monitoring beam respectively via the first transmission port and the second transmission port of the channel-side interface to the primary channel and the backup channel of the optical fiber;
a first optical sensing module, which is coupled to the first input port of the channel-side interface for detecting whether the primary channel of the optical fiber can normally transmit optical signal beam and the first monitoring beam injected by the monitoring beam generating module therein; and if yes, capable of generating a first opto-electro signal;
a second optical sensing module, which is coupled to the second reception port of the channel-side interface for detecting whether the backup channel of the optical fiber can normally transmit the second monitoring beam injected by the monitoring beam generating module therein; and if yes, capable of generating a second opto-electro signal; and
a communication module, which is capable of responding to the first opto-electro signal and the second opto-electro signal by generating a corresponding switching control signal to activate the first optical switching module and the second optical switching module to perform a failover switching action for switching the failed primary channel over to the backup channel.

2. The optical network transmission channel failover switching device of claim 1, wherein the optical network system is a PON (Passive Optical Network) system.

3. The optical network transmission channel failover switching device of claim 1, wherein the optical network system is an EDFA (Erbium-Doped Fiber Amplifier) equipped type of optical network system.

4. The optical network transmission channel failover switching device of claim 1, wherein the optical network system is a telephone-oriented optical network system.

5. The optical network transmission channel failover switching device of claim 1, wherein the local-side optical signal processing unit is an OLT (Optical Line Terminal) module.

6. The optical network transmission channel failover switching device of claim 1, wherein the remote-side optical signal processing unit is an ONU (Optical Network Unit) module.

7. The optical network transmission channel failover switching device of claim 1, wherein the monitoring beam generating module includes:
a laser diode for generating a laser beam;
an optical splitter for splitting the laser beam generated by the laser diode into two beams, respectively serving as the first monitoring beam and the second monitoring beam;
a first optical multiplexer for injecting the first monitoring beam into the primary channel of the optical fiber; and
a second optical multiplexer for injecting the second monitoring beam into the backup channel of the optical fiber.

8. The optical network transmission channel failover switching device of claim 7, wherein the first optical multiplexer and the second optical multiplexer are each a WDM (Wavelength Division Multiplexer) unit.

9. The optical network transmission channel failover switching device of claim 1, wherein the monitoring beam generating module includes:
a first laser diode for generating a laser beam for use as the first monitoring beam;
a second laser diode for generating a laser beam for use as the second monitoring beam;
a first optical multiplexer for injecting the first monitoring beam generated by the first laser diode into the primary channel of the optical fiber; and
a second optical multiplexer for injecting the second monitoring beam generated by the second laser diode into the backup channel of the optical fiber.

10. The optical network transmission channel failover switching device of claim 9, wherein the first optical multiplexer and the second optical multiplexer are each a WDM (Wavelength Division Multiplexer) unit.

11. The optical network transmission channel failover switching device of claim 1, wherein the first optical sensing module includes:
an optical splitter, which is coupled to the primary channel of the optical fiber for intercepting the optical signal beam and monitoring beam traveling in the primary channel to the second connecting port of the second optical switching module; and
a photo diode, for sensing the light intensity of the intercepted beam by the optical splitter.

12. The optical network transmission channel failover switching device of claim 1, wherein the second optical sensing module includes:
an optical splitter, which is coupled to the backup channel of the optical fiber for intercepting the optical signal beam and monitoring beam traveling in the backup channel to the third connecting port of the second optical switching module; and
a photo diode, for sensing the light intensity of the intercepted beam by the optical splitter.

13. The optical network transmission channel failover switching device of claim 1, wherein the first optical sensing module includes:
a WDM (Wavelength Division Multiplexer) module, which is coupled to the primary channel of the optical fiber for intercepting the optical signal beam and monitoring beam traveling in the primary channel to the second connecting port of the second optical switching module; and
a photo diode, for sensing the light intensity of the intercepted beam by the optical splitter.

14. The optical network transmission channel failover switching device of claim 1, wherein the second optical switching module includes:
a WDM (Wavelength Division Multiplexer) module, which is coupled to the backup channel of the optical fiber for intercepting the optical signal beam and monitoring beam traveling in the backup channel to the third connecting port of the second optical switching module; and
a photo diode, for sensing the light intensity of the intercepted beam by the optical splitter.

15. The optical network transmission channel failover switching device of claim 1, wherein the communication module is further capable of generating a backup channel failure notifying message in response to an event of a failure to the backup channel of the optical fiber.

16. The optical network transmission channel failover switching device of claim 1, further comprising:
an optical filter module, which is connected in a path of the optical signal beam, and which has a pass band of the wavelength of the optical signal beam for filtering out all the wavelengths other than the wavelength of the optical signal beam.

17. The optical network transmission channel failover switching device of claim 1, wherein the monitoring beam generating module, the first optical sensing module, and the second optical sensing module in combination includes:
a first optical splitter for intercepting the optical signal beam and the monitoring beam traveling through the primary channel to the second optical switching module;
a second optical splitter for intercepting the optical signal beam and the monitoring beam traveling through the backup channel to the second optical switching module;
a first optical transceiver instead of first laser diode and first photo diode for use to serve as the first monitoring beam, and meanwhile detecting whether the optical signal beam and the monitoring beams are being transmitted normally through the primary channel;
a second optical transceiver instead of second laser diode and second photo diode for use to serve as the second monitoring beam, and meanwhile detecting whether the optical signal beam and the monitoring beams are being transmitted normally through the backup channel;
a first optical multiplexer for injecting the optical beam from the first optical transceiver into the primary channel of the optical fiber; and
a second optical multiplexer for injecting the optical beam from the second optical transceiver into the backup channel of the optical fiber.

18. The optical network transmission channel failover switching device of claim 1, wherein the monitoring beam generating module, the first optical sensing module, and the second optical sensing module in combination includes:
a first optical splitter for intercepting the optical signal beam and the monitoring beam traveling through the primary channel to the second optical switching module;
a second optical splitter for intercepting the optical signal beam and the monitoring beam traveling through the backup channel to the second optical switching module;
a third optical splitter for injecting the optical beam from the first optical transceiver into the primary channel of the optical fiber; and
a fourth optical splitter for injecting the optical beam from the second optical transceiver into the backup channel of the optical fiber.
